(19) United States
(12) Patent Application Publication
(10) Pub. No.: US 2008/0118225 A1
(43) Pub. Date: May 22, 2008

(54) AUDIO AND VIDEO RECORDING AND PLAYING APPARATUS

(76) Inventor: Markus WIERZOCH, Taipei (TW)

Correspondence Address: BIRCH STEWART KOLASCH & BIRCH, PO BOX 747, FALLS CHURCH, VA, 22040-0747, US

(21) Appl. No.: 11/941,812

(22) Filed: Nov. 16, 2007

(30) Foreign Application Priority Data
Nov. 20, 2006 (TW) 095142752

(51) Int. Cl. H04N 5/91

(52) U.S. Cl. 386/96; 386/E09.001

(57) ABSTRACT

An audio and video recording and playing apparatus includes a container-like body and a lid. The container-like body has an audio and video recording and playing module. The audio and video recording and playing module receives and plays an audio and video signal. The lid is provided at an opening of the container-like body and electrically connected to the audio and video recording and playing module. The operation of the audio and video recording and playing module is controlled according to a relative position relationship between the lid and the container-like body.

### CROSS REFERENCE TO RELATED APPLICATIONS

This Non-provisional application claims priority under 35 U.S.C. §119(a) on Patent Application No(s). 095142752 filed in Taiwan, Republic of China on Nov. 20, 2006, the entire contents of which are hereby incorporated by reference.

### BACKGROUND OF THE INVENTION

1. Field of Invention

The invention relates to an audio and video apparatus and, more particularly, to an audio and video recording and playing apparatus.

2. Related Art

With the progress of the science and technology and the popularity of electronic products, an audio and video recording and playing apparatus has been one of important consumable electronic products. Nowadays, the two popular portable audio and video recording and playing apparatuses are the digital video (DV) and the digital still camera (DSC), and both of them have the audio and video recording and playing function and is recognized to be electronic products from the structure and exterior appearance. However, various consumable electronic products have been trended to be artistic, new, and fashionable from being functional, and consumers not only pay attention on the function, they pay more attention on the design and the form.

How to get both the audio and video recording and playing function and a special design, and make the audio and video recording and playing apparatus have a diverse product form to make consumers more willing to buy has been one of the important subjects.

### SUMMARY OF THE INVENTION

This invention provides an audio and video recording and playing apparatus which has both an audio and video recording and playing function and a special design, so that the audio and video recording and playing apparatus has a diverse product form.

To obtain the above objective, an audio and video recording and playing apparatus of the invention includes a container-like body and a lid. The container-like body has an audio and video recording and playing module for receiving and playing an audio and video signal. The lid is provided at an opening of the container-like body and electrically connected to the audio and video recording and playing module, wherein the operation of the audio and video recording and playing module is controlled according to the relative position relationship between the lid and the container-like body.

From the above, an audio and video recording and playing apparatus of the invention controls the operation and the operating mode of audio and video recording and playing module according to the connecting status between the lid and the container-like body. Compared with the conventional technology, the invention integrates the audio and video structure in the container-like body to make it have an audio and video recording and playing function and a special design, so that the audio and video recording and playing apparatus can have a diverse product form to make consumers more willing to buy.

### BRIEF DESCRIPTION OF THE DRAWINGS

FIG. 1 is a schematic diagram showing an audio and video recording and playing apparatus of a preferred embodiment of the invention.

FIG. 2 is a block diagram showing an audio and video recording and playing apparatus of a preferred embodiment of the invention.

FIG. 3A to FIG. 3C are schematic diagrams showing the operation of an audio and video recording and playing apparatus of a preferred embodiment of the invention.

### DETAILED DESCRIPTION OF THE INVENTION

An audio and video recording and playing apparatus of a preferred embodiment of the invention is described with the appended drawings, wherein the same reference numbers denote the same elements.

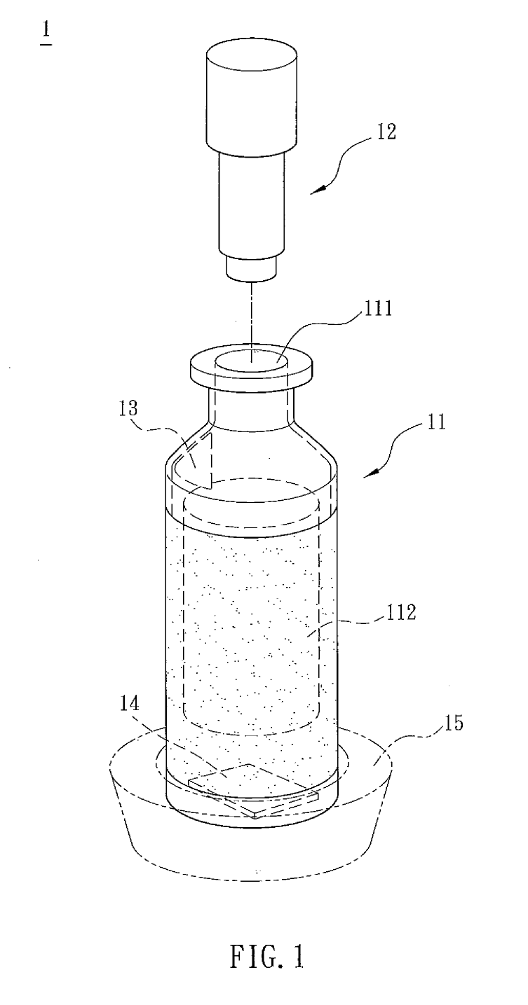

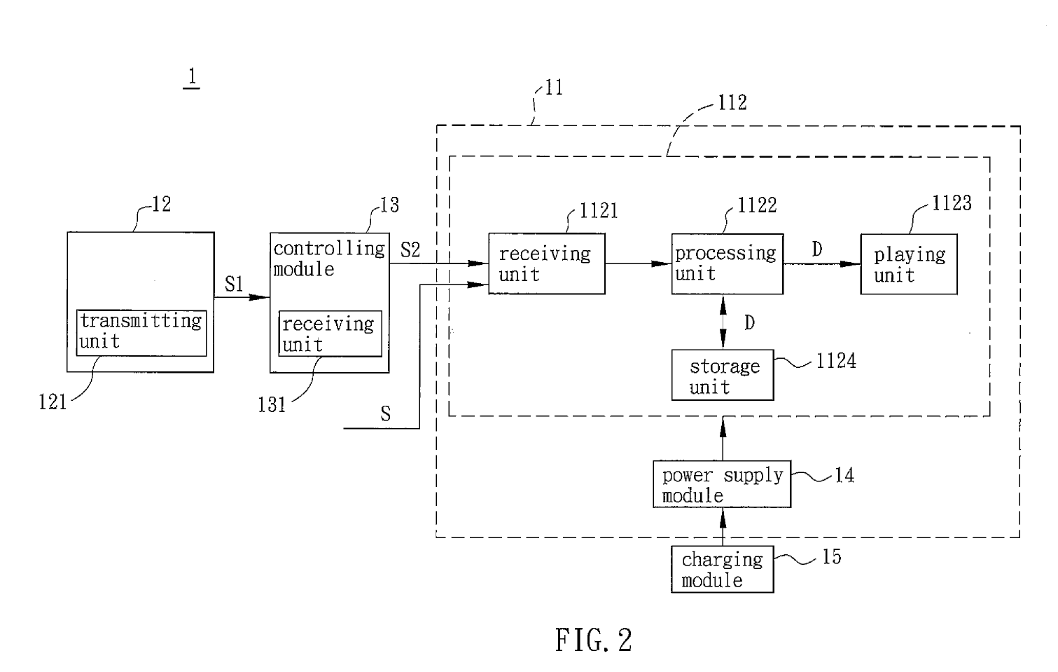

Refer to FIG. 1 and FIG. 2. An audio and video recording and playing apparatus 1 of a preferred embodiment includes a container-like body 11 and a lid 12. In the embodiment, the audio and video recording and playing apparatus 1 is, for example, container-like, and it may be bottle-like, cup-like, pot-like, round, square, polygonal or irregular, and so on.

The container-like 11 has an audio and video recording and playing module 112. The lid 12 is provided at an opening 111 of the container-like body 11, and the lid 12 is electrically connected to the audio and video recording and playing module 112. The audio and video recording and playing module 112 receives and plays an audio and video signal S according to the connecting status between the lid 12 and the container-like body 11.

The audio and video recording and playing apparatus 1 further includes a power supply module 14. The power supply module 14 is electrically connected to the audio and video recording and playing module 112 to supply it with power. In the embodiment, the power supply module 14 is provided in the container-like body 11, and it also is provided outside the container-like body 11 and electrically connected to the audio and video recording and playing module 112 via a wire (not shown in the figures).

The audio and video recording and playing apparatus 1 further includes a charging module 15. The charging module 15 is electrically connected to the power supply module 14 to charge up and supply power to the power supply module 14.

The audio and video recording and playing module 112 has a receiving unit 1121, a processing unit 1122 and a playing unit 1123. The processing unit 1122 is electrically connected to the receiving unit 1121 and the playing unit 1123, respectively. The lid 12 has a transmitting unit 121 which transmits a sensing signal S1 to the audio and video recording and playing module 112 according to the connecting status between the lid 12 and the container-like body 11. The receiving unit 1121 receives an audio and video signal S according to the sensing signal S1. The processing unit 1122 converts the audio and video signal S to audio and video data D and outputs the audio and video data D to the playing unit 1123 to play.

The audio and video recording and playing module 112 further has a storage unit 1124 which is electrically connected to the processing unit 1122. The storage unit 1124 can store the audio and video data D converted by the processing unit 1122. The receiving unit 1121, the processing unit 1122 and the storage unit 1124 is integrated into a processor.

Refer to FIG. 1 and FIG. 2 again. The audio and video recording and playing apparatus 1 further has a controlling module 13 electrically connected to the audio and video recording and playing module 112. The controlling module 13 is provided in the container-like body 11, and it also is provided outside the container-like body 11 and electrically connected to the audio and video recording and playing module 112. The controlling module 13 can detect the connecting status between the lid 12 and the container-like body 11 by the supersonic detecting, the wireless receiving and transmitting or the optical coupling, and the controlling module 13 receives different controlling signals and controls the operating mode of the audio and video recording and playing module 112 according to the connecting status between the lid 12 and container-like body 11. The wireless receiving and transmitting may be radio frequency identification (RFID).

When the controlling module 13 detects the connecting status between the lid 12 and the container-like body 11 by the wireless receiving and transmitting or the optical coupling, the controlling module 13 further has a receiving unit 131 which receives the sensing signal S1 transmitted by the transmitting unit 121 of the lid 12 and sends a controlling signal S2 to control the audio and video recording and playing module 112 of the container-like body 11 to receive or play the audio and video signal S. The receiving unit 1121 receives and plays the audio and video signal S according to the controlling signal S2 transmitted by the controlling module 13. Since the composition and functions of the receiving unit 1121, the processing unit 1122, the playing unit 1123 and the storage unit 1124 have been described in detail, they will not be described more for concise purpose.

The following will describe the operating mode of the audio and video recording and playing apparatus 1 of the preferred embodiment of the invention. In the embodiment, the audio and video recording and playing apparatus 1 is, for example, container-like, and the controlling module 13 is provided in the container-like body 11.

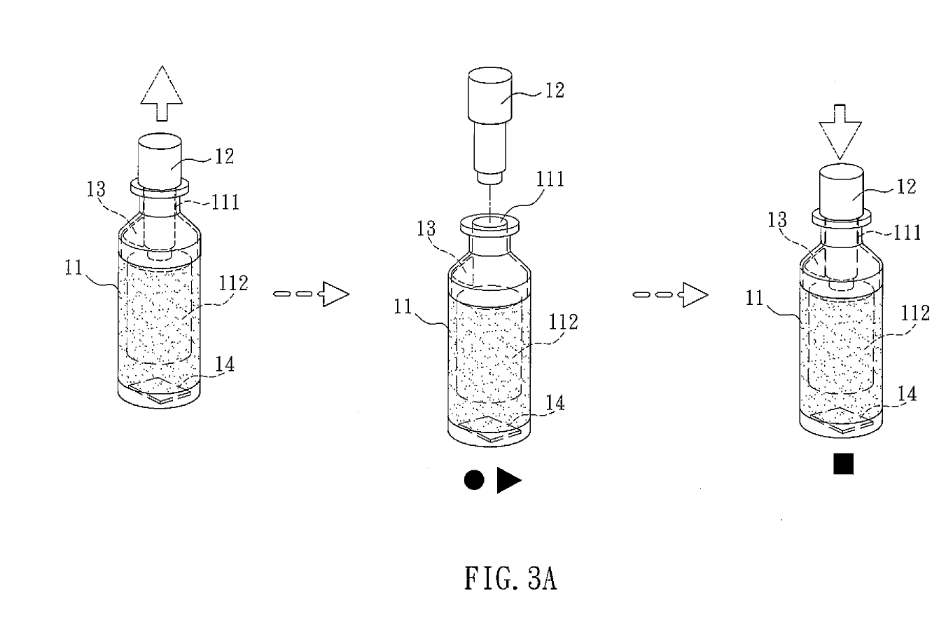

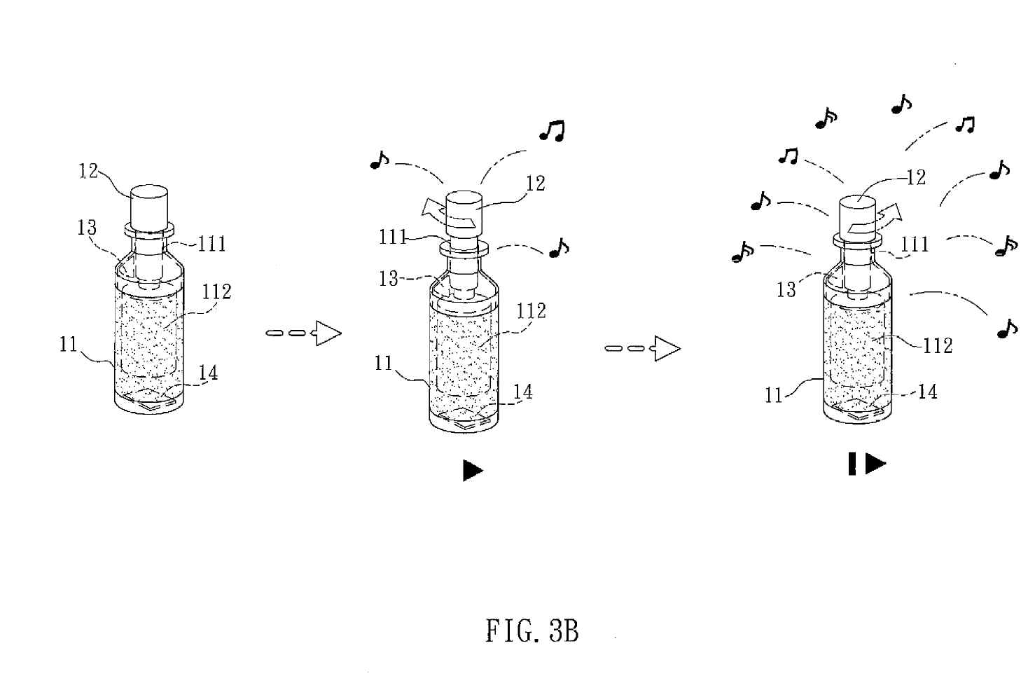

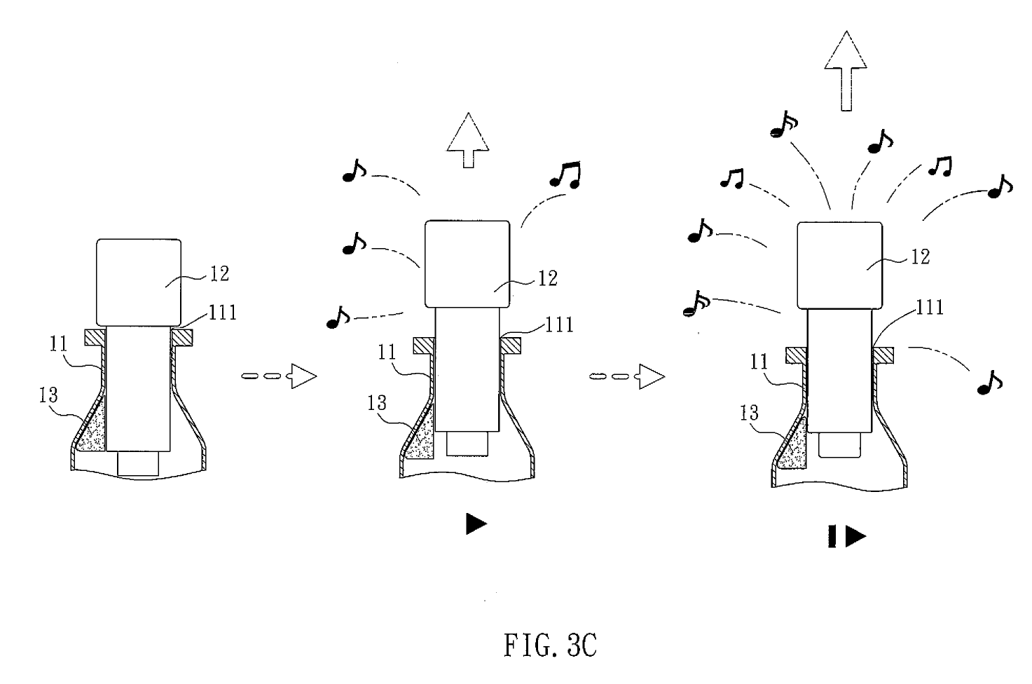

Refer to FIG. 3A. When users want to record and store audio and video data from the surroundings, they can separate the lid 12 from the container-like body 11, and then the controlling module 13 of the audio and video recording and playing apparatus 1 senses the sensing signal S1 of separating the lid 12 from the container-like body 11, and the controlling module 13 sends a controlling signal S2 to turn on the audio and video recording and playing module 112. At this moment, the receiving unit 1121 of the audio and video recording and playing module 112 receives the audio and video signal S from the surroundings, transmits the audio and video signal S to the processing unit 1122 to convert the audio and video signal S to audio and video data D, and stores the audio and video data D in the storing unit 1124, or transmits the audio and video data D to the playing unit 1123 to play synchronously. When users want to stop recording and storing the audio and video data from the surroundings, they can close the lid 12 to the container-like body 11, and then the controlling module 13 senses the sensing signal S1 of connecting the lid 12 and the container-like body 11. The controlling module 13 sends a controlling signal S2 to turn off the audio and video recording and playing module 112, and then the audio and video recording and playing module 112 stops recording and storing the audio and video data.

Refer to FIG. 3B. When the connecting status between the lid 12 and the container-like body 11 is changed by rotating the lid 12, for example, when the position of the lid 12 relative to the container-like body 11 is changed, the controlling module 13 receives the sensing signal S1 and transmits the controlling signal S2 to the audio and video recording and playing module 112. The controlling module 13 transmits a different controlling signal S2 to the audio and video recording and playing module 112 according to the rotating direction of the lid 12 or the rotating degree which makes the different position to switch the operating mode of the audio and video recording and playing module 112. For example, when the lid 12 rotates clockwise relative to the container-like body 11, the controlling module 13 senses the sensing signal S1 and transmits the controlling signal of playing S2 to the audio and video recording and playing module 112. The audio and video recording and playing module 112 receives the controlling signal S2 and makes the playing unit 1123 play the audio and video data D stored in the storage unit 1124. When the lid 12 rotates anticlockwise relative to the container-like body 11, the controlling module 13 also transmits different controlling signal S2 to the audio and video recording and playing module 112 to control the operating mode of the audio and video recording and playing module 112. Moreover, the controlling module 13 senses that whether the lid rotates clockwise or anticlock-wise relative to the container-body 1, and the transmitted controlling signal S2 may be the signal of playing, suspending, expressing or stopping and so on, and the corresponding function is executed.

Refer to FIG. 3C. When the depth of the cooperation between the lid 12 and the opening 111 of the container-like body 11 is adjusted by moving the lid 12, the controlling module 13 transmits different controlling signal S2 to the audio and video recording and playing module 112 according to the different depth of the cooperation between the lid 12 and the opening 111 to switch the operating mode of the audio and video recording and playing module 112. For example, when the depth of the cooperation between the lid 12 and the opening 111 of the container-like body 11 is one half of the total depth, the controlling module 13 senses the sensing signal S1 of the depth adjustment and transmits the controlling signal of playing S2 to the audio and video recording and playing module 112, and the audio and video recording and playing module 112 receives the controlling signal S2 and makes the playing unit 1123 play the audio and video data D stored in the storage unit 1124. When the depth of cooperation between the lid 12 and the opening 111 of the container-like body 11 is one quarter of the total depth, the controlling module 13 also transmits a different controlling signal 82 to the audio and video recording and playing module 112 to controlling the operating mode of the audio and video recording and playing module 112. The controlling module 13 senses the depth of cooperation between the lid 12 and the opening 111 of the container-like body 11, and the transmitted controlling signal S2 may be the signal of playing, suspending, expressing, or stopping, and so on.

Moreover, the audio and video recording and playing module 112 can receive and play the audio and video signal S synchronously. That is, the audio and video recording and playing module 112 can convert the audio and video signal S to the audio and video data D simultaneously to play when it receives the audio and video signal S. The receiving unit 1121 of the audio and video recording and playing module 112 may be a microphone, a camera, a photographic camera or any element which can receive an audio and video signal to receive audio and video data from the surroundings. The playing unit 1123 of the audio and video recording and playing module 112 may be an amplifier, a flat panel display (FPD) or any other element having a playing function to play the stored audio and video data D. The FPD may be a liquid crystal display (LCD), an organic light-emitting diode (OLED) display, a light-emitting diode (LED) display or an electrophoresis display, and the electrophoresis display may be an e-paper display. Moreover, the flat panel display may be a flexible display.

To sum up, an audio and video recording and playing apparatus of the invention can control the operation and the operating mode of an audio and video recording and playing module according to the connecting status between a lid and a container-like body. Compared with the conventional technology, the invention integrates the audio and video structure to a container-like body to make it have an audio and video recording and playing function and a special design, so that the audio and video recording and playing apparatus of the invention can have a diverse form to make consumers more willing to buy.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An audio and video recording and playing apparatus comprising:
a container-like body having an audio and video recording and playing module for receiving and playing an audio and video signal; and
a lid provided at an opening of the container-like body and electrically connected to the audio and video recording and playing module, wherein the operation of the audio and video recording and playing module is controlled according to the relative position relationship between the lid and the container-like body.

2. The audio and video recording and playing apparatus according to claim 1, wherein closing the lid to the container-like body or separating the lid from the container-like body can make the audio and video recording and playing module start or stop receiving the audio and video signal.

3. The audio and video recording and playing apparatus according to claim 1, wherein the audio and video recording and playing module receives a controlling signal which is a signal of playing, suspending or stopping and executes the corresponding function.

4. The audio and video recording and playing apparatus according to claim 3, wherein the position of the lid relative to the container-like body is changed by rotating the lid, and the different controlling signal is transmitted to the audio and video recording and playing module according to the position.

5. The audio and video recording and playing apparatus according to claim 3, wherein the depth of the cooperation between the lid and the opening is adjusted by moving the lid, and the different controlling signal is transmitted to the audio and video recording and playing module according to the depth.

6. The audio and video recording and playing apparatus according to claim 1, wherein the audio and video recording and playing module receives and plays the audio and video signal synchronously.

7. The audio and video recording and playing apparatus according to claim 1, wherein the audio and video recording and playing module comprises:
a receiving unit receiving the audio and video signal according to the connecting status between the lid and the container-like body;
a processing unit electrically connected to the receiving unit and converting the received audio and video signal to audio and video data; and
a playing unit electrically connected to the processing unit to play the audio and video data.

8. The audio and video recording and playing apparatus according to claim 7, wherein the audio and video recording and playing module further comprises:
a storage unit electrically connected to the processing unit to store the audio and video data.

9. The audio and video recording and playing apparatus according to claim 7, wherein the receiving unit is a microphone, a camera or a photographic camera.

10. The audio and video recording and playing apparatus according to claim 7, wherein the playing unit is an amplifier or a flat panel display.

11. The audio and video recording and playing apparatus according to claim 10, wherein the flat panel display is a liquid crystal display (LCD), an organic light-emitting diode display (OLED), a light-emitting diode (LED) display or an electrophoresis display.

12. The audio and video recording and playing apparatus according to claim 11, wherein the electrophoresis display is an e-paper display.

13. The audio and video recording and playing apparatus according to claim 10, wherein the flat panel display is a flexible display.

14. The audio and video recording and playing apparatus according to claim 7 further comprising:
a controlling module electrically connected to the audio and video recording and playing module, wherein the controlling module receives a controlling signal which is a signal of playing, suspending, expressing or stopping and controls the audio and video recording and playing module to execute the corresponding function.

15. The audio and video recording and playing apparatus according to claim 14, wherein the controlling module detects the connecting status between the lid and the container-like body by the supersonic detecting, the wireless receiving and transmitting or the optical coupling to receive the different controlling signal.

16. The audio and video recording and playing apparatus according to claim 15, wherein the lid has an transmitting unit to provide different sensing signals, and the controlling module has a receiving unit to receive the sensing signal provided by the transmitting unit.

17. The audio and video recording and playing apparatus according to claim 15, wherein the wireless receiving and transmitting utilizes the radio frequency identification (RFID) technology.

18. The audio and video recording and playing apparatus according to claim 1 further comprising:
a power supply module electrically connected to the audio and video recording and playing module to provide the needed power supply for the operation of audio and video recording and playing module.

19. The audio and video recording and playing apparatus according to claim 18 further comprising:
a charging module electrically connected to the power supply module to charge up the power supply module.

20. The audio and video recording and playing apparatus according to claim 1, wherein the form of the container-like body is bottle-like, cup-like or pot-like.
